(19) United States
(12) Patent Application Publication
(10) Pub. No.: US 2007/0238587 A1
(43) Pub. Date: Oct. 11, 2007

(54) DVT prevention apparatus

(76) Inventor: Rosemary Darben, Middletown, NJ (US)

Correspondence Address: Charles I. Brodsky, 2 Bucks Lane, Marlboro, NJ, 07746, US

(21) Appl. No.: 11/398,901

(22) Filed: Apr. 7, 2006

(51) Int. Cl. A61H 1/02; A61H 3/04; A63B 21/00; A61H 1/00

(52) U.S. Cl. 482/68; 601/23; 482/132

(57) ABSTRACT

A sole plate worn beneath the stockinged foot or shoe of a long distance traveller, or one whose ability to get up and walk about is limited or restricted, is provided with rolling means at a lower surface thereof to afford both linear and rotational motion of the plate when worn, in preventing deep vein thrombosis and possible pulmonary embolism to the user.

### CROSS-REFERENCE TO RELATED APPLICATIONS

None.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to prevention of deep vein thrombosis, in general, and to the prevention of deep vein thrombosis for travellers, for those bedridden or confined to wheelchairs and for those recovering from lower extremities operations, in particular.

2. Description of the Related Art

As is well known and understood, deep vein thrombosis (also called DVT) is a blood clot that can develop in a vein deep inside the body, usually in the leg. While a fairly common condition causing pain in the leg, it can become dangerous if the clot breaks free and travels through the bloodstream to block a blood vessel in the lungs. Such blockage—termed a pulmonary embolism—can cause sharp chest pain or breathlessness, and can be life-threatening if the circulating clot is large.

As is also well known and understood, deep vein thrombosis occurs most frequently among people who are immobilized. Because travel by any mode of transportation usually requires immobility at least during some portion of a journey, it is not surprising that travellers occasionally experience deep vein thrombosis, with some developing pulmonary embolism. While long journeys by car, bus or train, can present these types of symptoms, those involving long air flights to the Orient, Australia and Hawaii frequently give rise to this experience of DVT.

As will be further appreciated, suggestions for preventing deep vein thrombosis have often been proposed. Recommended most is the exercising of the legs by walking up and down the aisle of a bus, train or plane where possible. Where inconvenient to do so, pushing the toes towards the knees followed by relaxing, or by pressing the balls of the feet down while raising the heel, have been proposed. Wearing loose, non-restrictive clothing, keeping the legs uncrossed when sitting, drinking plenty of non-alcoholic fluids to stay hydrated are other suggestions, as is simply placing a cushion under the feet to raise the feet higher than the hips.

While all such preventive measures are helpful, for air travel, the movement up and about an air cabin by walking forward and back down its aisle can be such that the risk of injury from any turbulence that may occur might very well outweigh the benefits of the exercise against this “traveller's thrombosis”.

### OBJECTS OF THE INVENTION

It is an object of the present invention, therefore, to provide a new and improved DVT preventive apparatus for travellers to be used while seated during long journeys.

It is an object of the invention, also, to provide such preventive apparatus of a nature which can be easily stored after use.

It is another object of the invention to provide such DVT preventive apparatus of a construction which can be provided a passenger by the carrier for use and/or brought onto the transport by the user himself/herself.

### SUMMARY OF THE INVENTION

As will become clear from the following description, the DVT prevention apparatus for travellers according to the invention can be easily carried about, can be easily put on, is extremely simple to use, and is sufficiently small that it can be easily stowed away after use without taking up much room. As will be seen, the apparatus can be strapped or otherwise secured to the sole of a passenger's shoe in one embodiment of the invention, or can be simply strapped about the foot by means of VELCRO type hook-and-loop securements.

In particular, the deep vein thrombosis preventive apparatus embodying the invention includes a sole plate having upper, lower and opposite side surfaces, along with rolling means at the lower surface for affording both linear and rotational motion to the plate when the plate is being worn on the foot of a user thereof. Attachment means are then included, coupled with the plate, to span across the upper surface for securing the plate beneath the foot of the user wearing the plate. A forward, rearward, sideways and rotational motion will thus be seen to result when the rolling means includes four rotational wheels positioned at the North, South, East and West locations at the lower surface of the sole plate. In such preferred embodiment, the attachment means can be selected of a length to extend and span across the upper surface of the plate for securing the plate either beneath the foot of the user or beneath a shoe worn on the user's foot (i.e., with a somewhat longer attachment arrangement).

As will be appreciated by those skilled in the art, such attachment means can span across the upper surface of the sole plate from between opposing locations on the side surfaces of the plate, between opposing locations on the upper surface instead, or between one side surface and an upper surface oppositely positioned with respect thereto. In one embodiment of the invention, a plurality of casters may be employed rotatably coupled to the lower surface of the sole plate, along with an attachment means of a type including two sections of a conventional VELCRO hook-and-loop strap fastener.

As will additionally be readily understood, apparatus of this type can also prove useful to those persons who are bedridden or confined to wheelchairs, and to those recovering from lower extremities operations, in preventing the formation of pain causing, and possibly life threatening, blood clots.

### BRIEF DESCRIPTION OF THE DRAWINGS

These and other features of the present invention will be more clearly understood from a consideration of the following description, taken in connection with the accompanying drawings, in which:

FIGS. 1 and 2 are bottom and top views, respectively, of the deep vein thrombosis prevention apparatus embodying the invention;

FIGS. 3 and 4 are pictorial views illustrating how the apparatus of the invention may be secured beneath a foot or beneath a shoe of a user wearing the apparatus of the invention; and

FIGS. 5-7 are pictorial views illustrating how the prevention apparatus may be secured in place.

### DETAILED DESCRIPTION OF THE INVENTION

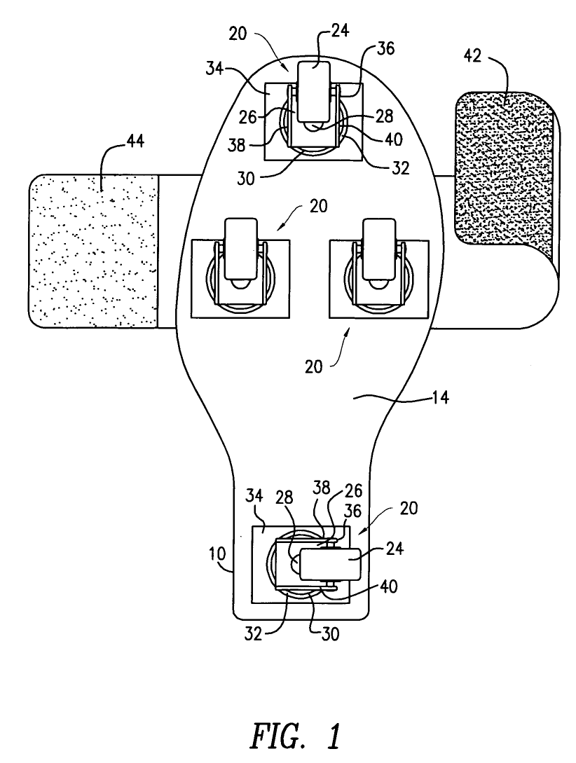

In the Drawings, the sole plate of the DVT prevention apparatus is shown at 10 as having an upper surface 12, a lower surface 14 and opposing side surfaces 16, 18. Rolling means 20—e.g. ball bearings, rotating wheels, casters, or any type of rollers—are rotatably coupled to the lower surface 14 of the sole plate 10—for example, as with casters 24 rotatable clockwise and counterclockwise in a horizontal plane through a generally U-shaped clip 26 joined with the lower surface 14 via a pin 28 and an O-ring 30 within a recess 32 of a disk 34 joined with the lower surface 14. Unrestricted clockwise and counterclockwise rotation of the clip 26 and caster 24 is thereby afforded, and rolling action of the caster 24 itself follows through a further pin 36 extending through the caster 24 between opposing walls 38, 40 of the clip 26. As FIG. 1 illustrates, four such similar arrangements are preferably utilized—at North, South, East and West locations on the lower surface 14 allow forward, rearward, and sideways linear motion of the sole plate 10, and rotational motion of it as well when worn on a foot of a user. While two or three such rolling wheel or roller arrangements may be employed with the invention, four such configurations are deemed preferable as such number, in the locations indicated in FIG. 1, provide a best balance for the wearer.

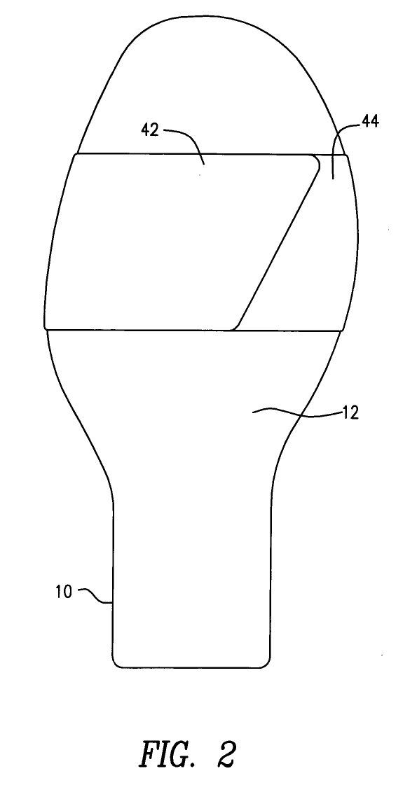

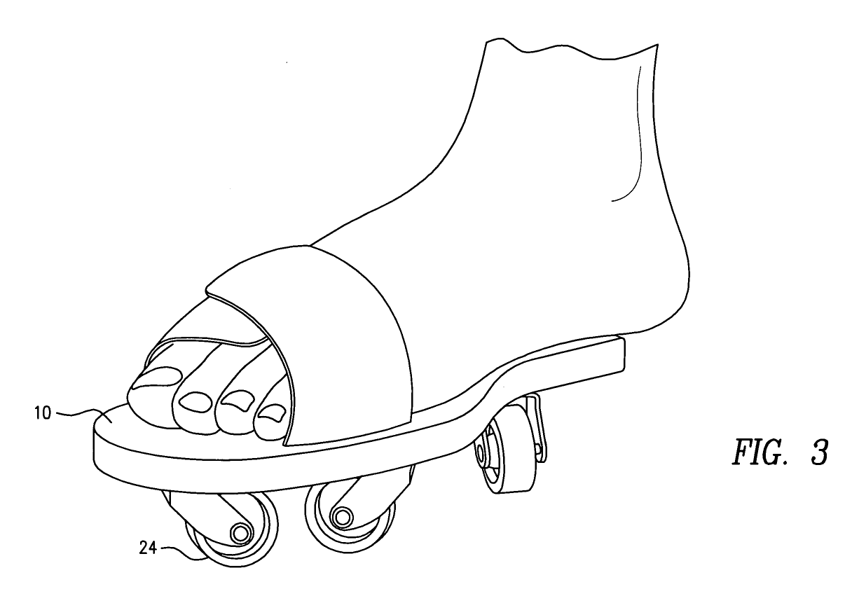

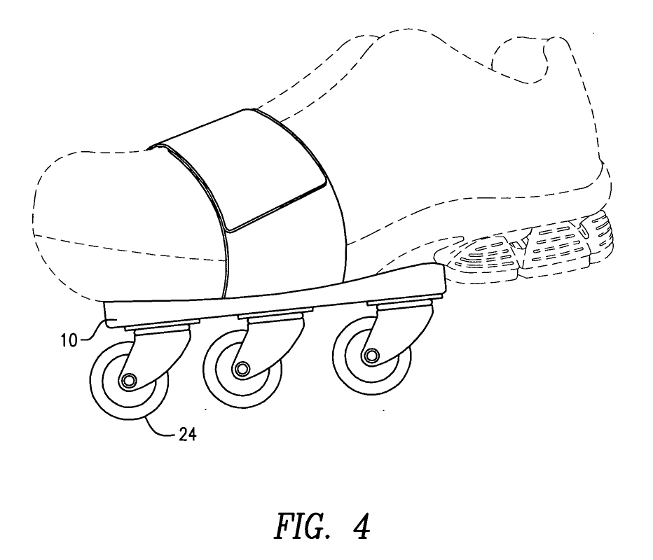

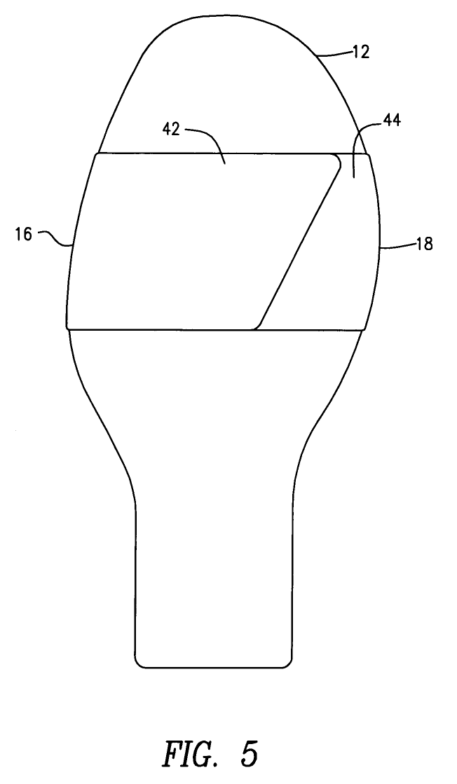

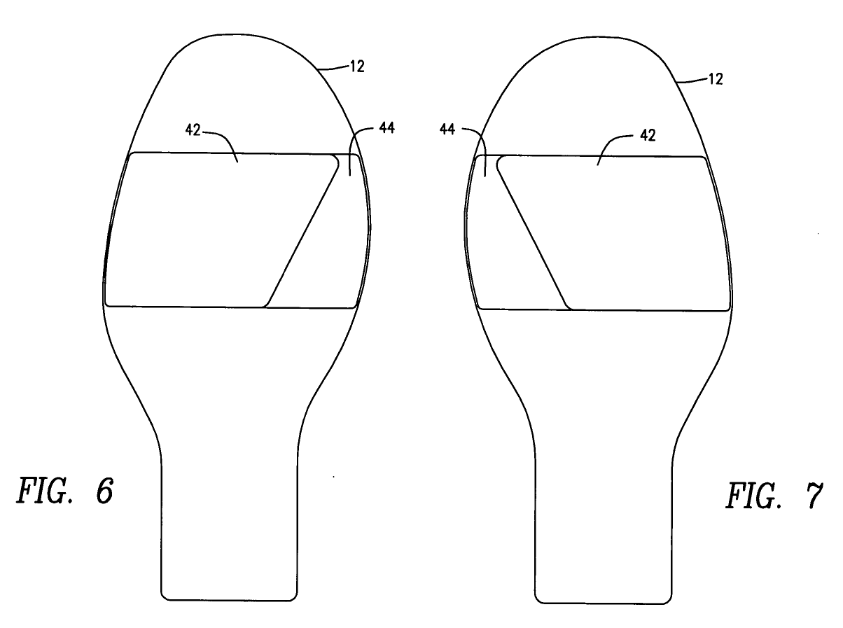

FIG. 1 also shows—as does FIG. 2—a means of attaching the sole plate to the foot of the wearer, beneath either a shoe being worn (FIG. 4) or beneath just a stockinged foot (FIG. 3). Shown as two sections 42, 44 of a conventional VELCRO hook-and-loop strap fastener, the sections 42, 44 span across the upper surface 12 of the sole plate 10 over the foot or shoe, to couple together as in the view of FIG. 2 for holding in place. As will be appreciated by those skilled in the art, this type of VELCRO attachment means may span across the upper surface 12 extending between opposing locations on the side surfaces 16, 18 (FIG. 5), between opposing locations on the upper surface 12 (FIG. 6), or between one side surface (as 16) and the upper surface 12 (FIG. 7). No matter which method of attachment of the hook-and-loop strap fastener is used, the finality of the wearing of the DVT prevention apparatus is as shown in FIG. 3 or 4.

In use, all that need be done is to slip the apparatus onto the stocking feet or over the shoes being worn. The sole plate 10 then rests beneath the foot or beneath the shoe, as the case may be, and is attached by fastening the two VELCRO hook-and-loop straps 42, 44. While sitting, a user could then roll his/her feet forward, rearward, sideways, linearly, or just rotate them around in place.

Because of its relatively small size, the DVT prevention apparatus can easily be stowed away after use, can be carried on board the bus, train or plane by the traveller or can even be loaned or given to the traveller by the transport carrier. Although prevention of DVT and pulmonary embolism can best be had by walking about as frequently as possible, it is often impractical to walk up and down an airplane aisle, or that of a train in motion, just as it is often impractical to stop a car at every rest stop for a walk. Understanding that the DVT pains in airplane flight are not limited to economy class passengers where it was thought to be linked to cramped seating in coach class, and that the leg pains and possible embolism can follow for passengers in business and first class as well, the prevention apparatus of the invention greatly reduces the hazards of forming pulmonary emboli in an effective manner that makes long term travelling that much safer. The same benefit will obviously be seen to follow from a similar use by anyone whose ability to get up and walk about is limited or restricted.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the invention.

I claim:

1. DVT prevention apparatus comprising:
a sole plate having upper, lower and opposing side surfaces;
rolling means at said lower surface for affording both linear and rotational motion to said plate when said plate is being worn on a foot of a user thereof; and
attachment means coupled with said plate to span across said upper surface for securing said plate beneath the foot of said user wearing said plate.

2. The DVT prevention apparatus of claim 1 wherein said attachment means couples with said plate to span across said upper surface for securing said plate beneath a shoe worn on said user's foot.

3. The DVT prevention apparatus of claim 1 wherein said attachment means spans across said upper surface between opposing locations on said side surfaces of said sole plate.

4. The DVT prevention apparatus of claim 1 wherein said attachment means spans across said upper surface between opposing locations on said upper surface of said sole plate.

5. The DVT prevention apparatus of claim 1 wherein said attachment means spans across said upper surface between opposing locations on one side surface of said sole plate and said upper surface.

6. The DVT prevention apparatus of claim 1 wherein said attachment means includes two sections of a VELCRO hook-and-loop strap fastener.

7. The DVT prevention apparatus of claim 1 wherein said rolling means includes a plurality of casters rotatably coupled to said lower surface of said sole plate.

8. The DVT prevention apparatus of claim 7 wherein said rolling means includes 4 rotating casters positioned at North, South, East and West locations of said lower surface of said sole plate.
